(19) United States
(12) Patent Application Publication
(10) Pub. No.: US 2005/0284377 A1
(43) Pub. Date: Dec. 29, 2005

(54) Systems and method for milking domesticated animals

(76) Inventor: Anatoli Ganeev, Moscow (RU)

Correspondence Address: KALIKO & YEAGER, L.L.C., 500 NORTH FRANKLIN TURNPIKE, RAMSEY, NJ, 07446, US

(21) Appl. No.: 10/877,679

(22) Filed: Jun. 25, 2004

(51) Int. Cl. A01J 5/06

(52) U.S. Cl. 119/14.02

(57) ABSTRACT

Systems and methods for milking domesticated animals are provided. A system according to the invention may include a sub-mastitic circumferential chamber; a plurality of prominences that line the interior of the sub-mastitic circumferential; a constant vacuum chamber; and a pulse vacuum tube. A method according to the invention may include providing a sub-mastitic circumferential chamber, providing a plurality of prominences that line the interior of the sub-mastitic circumferential chamber; providing a constant vacuum chamber located below the sub-mastitic circumferential chamber; providing a pulsed vacuum to the sub-mastitic circumferential chamber; providing a constant vacuum to the constant vacuum chamber; and generating an inductive vacuum between the upper and lower area of the sub-mastitic chamber and the skin of an animal's teat.

### BACKGROUND OF THE INVENTION

The present invention is related to the agricultural sector. More particularly, this invention is related to systems and methods for milking domesticated animals (cows, goats, camels, sheep, etc.).

Contemporary milking systems and methods that cover and are closely associated with the functional characteristics of the prior art have many problems associated with their use. For example, contemporary milking systems and methods have problems relating to their functionality, expediency, animal health, milk hygiene, the number of items per assembly, and energy consumption. A more detailed description of the problems associated with contemporary milking systems and methods are described as follows:

Many, if not all, of the prior art milking apparatuses include liners in the milking cup that cover and touch the end of the animal's teat. Coverage of and harm to the animal and contamination to the milk extracted from the animal. For example, such coverage of and contact with the animal's teat by the liner may harbour and facilitate mastitis infections and teat sinus stripping.

To further elaborate, the use of a liner that covers and touches the end of the animal's teat may produce liner slips/crawls. These slips/crawls may generate vacuum fluctuations that may propel milk that may contain bacteria directly from the exterior of the teat into the teat sinus, causing mastitis infections. In addition to slips/crawls, there may also be liner drops. Liner drops contaminate the liner and bring the mastitis bacteria in contact with the teat rendering it more susceptible for colonization or multiplication of mastitis bacteria. The above-described trauma to the animal's teat may not only cause discomfort and pain to the animal, but may also lead to neurohormonal responses that suppress immune function and interfere with milk letdown. Such responses may result in incomplete milking.

Other problems associated with the use of the prior art milking devices arise due to the complexity and the nature of their designs. Typically the milking devices associated with the prior art are comprised of several components. In many cases the prior art milking devices contain two to five components for each teat. The complexities of these devices often require significant assembly and disassembly time from personnel. In addition, many of the prior art designs create an internal curvature of the liner or have movement in the liner both of which may bring the liner into contact with the milk flow. Such contact with the milk flow may cause the separating of fat from the milk and the depositing of this fat on the liner walls causing a quicker dilapidation of the liner's condition and the quicker curdling of the milk.

In addition, many of the prior art milking devices operate with a vacuum of 50-60 KPa. Vacuums operating at this pressure level may damage the animal's keratin sphincter located on the end of the teat and may cause stripping and over milking.

In view of the potential harm that may come to an animal and the milk extracted during the milking process, improved systems and methods for milking animals are needed. Therefore, it would be desirable to provide improved milking systems and methods that overcome the above-described problems associated with the use of the prior art systems and methods for milking domesticated animals.

### SUMMARY OF THE INVENTION

An object of the present invention is to provide improved systems and methods that help to provide a safer and more effective milking procedure for the animals being milked. Safety may be achieved by reducing the likelihood that contaminants may come in contact with the teat, teat end, and milk flow. Safety may also be achieved reducing the possibility of blood flow constriction or tramatization the animal's teat.

Efficiency may be achieved by decreasing the milk out time, reducing residual milk, production and replacement costs, providing easier monitoring for operators, reducing power consumption, reducing overall weight, and reducing the sickness rates of animals.

Another object of the present invention is to provide systems and methods that help to prevent contamination of milk during the milking process. This may be achieved by substantially constant adherence of the system to the teat during operation.

A further object of the present invention is to provide an improved milking device that utilizes vacuum pressures below 50-60 KPa to extract milk from an animal. This may be achieved by incorporating fewer moving parts.

Still a further object of the present invention is to provide an improved milking device that requires less maintenance and has a longer life cycle than the prior art systems. This may be achieved by the materials used to construct the milking device and the incorporation of a design that may be easier to clean because of the absence of any enclosed angles.

An apparatus according to the invention may include a sub-mastitic circumferential chamber. The sub-mastitic circumferential chamber is designed to reach in height from substantially the apex of an animal's teat down to substantially the mid-section of the teat. The system may also include a plurality of prominences that line the interior of the sub-mastitic circumferential chamber and massage the animal's teat to produce a suckling sensation that fosters the natural flow of milk from the animal. The system may further include a constant vacuum chamber and a pulse vacuum tube. The constant vacuum chamber may be located below the sub-mastitic circumferential chamber and may provide for the conveyance of a constant vacuum. The pulse vacuum tube may be connected to the sub-mastitic circumferential chamber and may provide for the conveyance of a pulsating vacuum. The pulse vacuum tube may enter the sub-mastitic chamber at a point located above the vertical midpoint of the sub-mastitic chamber to in order to produce an efficient inductive vacuum that helps to foster milk flow from the animal's teat.

A method according to the invention may include providing a sub-mastitic circumferential chamber that may be designed to reach in height from substantially the apex of an animal's teat down to substantially the mid-section of the teat. The chamber may further include an upper and a lower area where the upper area of the chamber is constructed narrower than that of the lower area. The method may further include providing a plurality of prominences that line the interior of the sub-mastitic circumferential chamber; providing a constant vacuum chamber located below the sub-mastitic circumferential chamber; providing a pulsed vacuum to the sub-mastitic circumferential chamber; providing a constant vacuum to the constant vacuum chamber; and generating an inductive vacuum between the upper and lower area of the sub-mastitic chamber and the skin of an animal's teat.

The above and other objects, features, and advantages of the present invention will become apparent upon consideration of the following detailed description, taken in conjunction with the accompanying drawings in which like reference characters refer to like parts throughout.

### BRIEF DESCRIPTION OF THE DRAWINGS

FIG. 1 shows an illustrative embodiment of a cross section of an embodiment according to the invention.

### DETAILED DESCRIPTION OF THE PREFERRED EMBODIMENTS

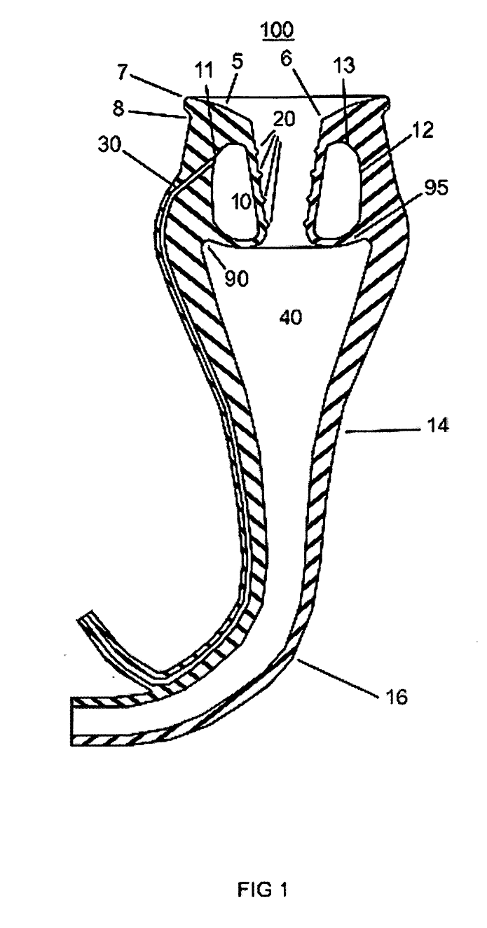

Referring to FIG. 1, system 100 may include a preformed circumferential sub-mastitic chamber 10, which pulsates with the application of pulsed vacuum. The inner most circumference of chamber 10 is designed to accommodate an animal teat, much like a hollow ring around a finger. When placed in its working position, chamber 10 is designed to reach in height from almost the apex of the teat (the point where the udder starts), down to almost the mid-section of the teat, yet never reaching as far down as the teat end. This ensures that the sensitive area of the teat (the teat end) is never in contact with any element of system 100.

The innermost circumference of chamber 10 may include a plurality of horizontal prominences 20 that are in direct contact with the periphery of the teat. Prominences 20 may be placed in at least four horizontal lines along the innermost circumference of chamber 10. Prominences 20 may also be placed along the innermost circumference of chamber 10 in an alternating chessboard manner. Prominences 20 may be smoothly constructed so as not to damage the animal's teat, and their thickness may be gradually reduced to that of the neighboring areas so as to avoid angles which could damage the sensitive teat skin. The wall of chamber 10 may have a varying thickness. For example, the thickness of chamber 10 may be reduced in areas where prominences 20 may be located to allow for the expansion and contraction of chamber 10 during the application of a pulsed vacuum, while the area that does not contain any prominences 20 may be thicker in order to assist in maintaining the configuration of the areas of chamber 10 that do not contain any prominences 20, regardless of the vacuum applied.

The upper part of chamber 10 may be constructed in such a manner to rest against the animal's udder. Chamber 10 may also be constructed such that the diameter of the inner most circumference is large enough to loosely accept an animal's teat. The lower part of chamber 10 may be constructed such that it gradually decreases in diameter so that the animal's teat fits snugly through the base of chamber 10. It should also be noted that the diameter of chamber 10 may vary based upon the size of the animal's teat and the type of animal being milked.

Once the animal's teat is inserted into system 100 and the system is placed into operation, a pulse vacuum, preferably less than 35 Kilopascal (KPa), may be conveyed into chamber 10 via pulse vacuum line 30. When such a vacuum is applied, prominences 20 located toward the upper portion of chamber 10 may retract away from the animal's teat, while the lowermost prominences 20 may remain in constant contact with the animal's teat. The ability to pulsate upper prominences 20 while keeping lower prominences 20 in constant contact with the animal's teat creates an inductive vacuum in the area between the uppermost and lowermost prominences 20 and the adjacent teat skin. This inductive vacuum forces system 100 to be displaced upwardly on the animal's teat, thus helping to prevent “liner drops” or “crawls”. This displacement action also mildly massages the teat and creates a neurohormonal reaction in the animal that enhances and promotes milk letdown. Moreover, the above-described inductive vacuum causes the teat sinus to expand and temporarily increases the diameter of the animal's teat sinus, thus, helping to provide a more constant and productive milk flow.

As mentioned above, during operation a pulsating vacuum may be conveyed to chamber 10 via pulse vacuum line 30. Pulse vacuum line 30 may be variably connected to a periodic vacuum means. Pulse vacuum line 30 may be located along the outermost walls of system 100 and may enter chamber 10 at a point along the vertical axis of chamber 10. In one embodiment, pulse vacuum line 30 may enter chamber 10 at a point above the vertical midpoint of chamber 10 to ensure that the applied vacuum is first exerted on the higher portions of chamber 10 and then to progressively lower portions of chamber 10. For example, FIG. 1 shows the pulse vacuum line 30 being inserted into chamber 10 at insertion point 11, which is located at the top of chamber 10. In addition to the location of pulse vacuum line 30, FIG. 1 also shows that the curvature of the top inner surface of outer wall 12 and the top inner surface of inner wall 13 of chamber 10 may be narrower than that of the lower portions of chamber 10. These narrower curvatures help to ensure that the applied vacuum is first exerted on the higher portions of chamber 10 and then to progressively lower portion of chamber 10. Those skilled in the art will appreciate that the curvatures of the top portion of chamber 10 may be constructed in any suitable manner so as to ensure that the applied vacuum is first exerted on the higher portions of chamber 10 and then to progressively lower portion of chamber 10. Although not shown, it should be noted that pulse vacuum line 30 may be connected to an independent pulse vacuum or to a pulse vacuum integrated into a milk collector.

System 100 may also include constant vacuum chamber 40 located under the end of the animal's teat. Constant vacuum chamber 40 may be used to apply a constant vacuum that conveys the animal's milk to a milk collection means (e.g., a milking manifold, milking canister, etc.)(not shown). The constant vacuum applied maintains the animal's teat end sphincter open at all times that a vacuum is applied. Constant vacuum chamber 40 may be constructed in a manner to ensure that its diameter is wide enough at its upper portion to ensure that chamber 10, located above chamber 40, maintains proper functionality and to ensure that the animal's teat never comes in contact with the outer walls of chamber 40 during operation. As shown in FIG. 1, chamber 40 may also be constructed to ensure that the chamber smoothly narrows in diameter towards the chamber's bottom portion. For example, chamber 40 may be constructed as a reverse cone with a cut tip (point down) to ensure undisturbed, undisrupted, and smooth milk flow with the least amount of agitation as possible.

As chamber 40 continues to narrow in diameter it begins to form constant vacuum line 16 that may be attached to a constant vacuum means (not shown). Constant vacuum line 16 is preferably constructed from rigid or semi-rigid materials. As shown in FIG. 1, constant vacuum line 16 may be substantially horizontal with respect to chamber 40. The formation of constant vacuum line 16 to its horizontal orientation from chamber 40 should be a gradual transition so as to avoid the formation of sharp angles. This gradual transition helps prevent the agitation of the milk and ensures that a constant and stable vacuum is maintained.

In one embodiment, as shown in FIG. 1, top walls 5 may be constructed to be smoothly angled towards the interior of system 100. The smooth inward angle of top walls 5 follows the natural structure of the upper parts of the teat and helps to ensure stress-free contact with the animal. In one embodiment, the interior portion of top walls 5, as shown on FIG. 1 at point 6, may be constructed to form a smoothly angled corner in order to sufficiently seal around the animal's teat so that the above-described inductive vacuum may be produced without exerting excessive pressure on the animal's teat. The curvature of top wall 5 at point 6 may also assist in the adherence of system 100 on the animal's teat during operation and may assist in the avoidance of “liner crawls”.

In some embodiments, as shown in FIG. 1 at point 7, the outermost area of top walls 5 may be constructed in such a manner so as to follow the natural shape of the teat as it is connected to the udder. Following the natural construction of the teat as it is connected to the udder has the effect of emulating a suckling animal's lips around its mother's teat, thus, assisting in providing a more stress free environment for the animal being milked.

In some embodiments, as shown in FIG. 1 at point 8, the diameter of system 100 may be slightly decreased in size before continuing on to form the reverse cone shape of system 100 as described above. This slight decrease in diameter may assist operators to ensure better placement of system 100 in an operating position without the operators having to physically touch the animal's teat, thus, helping to ensure the decreased possibility for transference of contaminants to the teat. In addition to helping reduce the possibility of contaminants, the decrease in diameter at point 8 may also serve as support structure in the event that the pulsed vacuum conveyed to chamber 10 exceeds a nominal level.

Some embodiments of system 100 may include sloping curves in the outer and lower walls of pulse vacuum chamber 10, as shown in FIG. 1 at points 90 and 95. These curves structurally support system 100 and due to their smooth sloping nature provide for easy maintenance and cleaning. Curves 90 and 95 support the chamber 10 by providing chamber 10 the ability to conform to a new shape after an animal's teat is inserted. The location of curves 90 and 95 also may be designed to take up any slack that may be in the lower part of chamber 10. Curves 90 and 95 may also be used to support the operation of system 100 by helping to ensuring that the surfaces between curves 90 and 95 and prominences 20 do not contract during the application of pulsed vacuum. Finally, the smooth design of curves 90 and 95 may assist in the sanitation of system 100 by allowing water or other cleaning agents to easily flow away from after being applied.

The above-described components of system 100 may be constructed with a variety of flexible diaphanous materials. For example, the above-described components may be constructed of elastomers, polymers, plastics, or any other suitable organic or inorganic materials. The above described components may also incorporate antibacterial properties. In some embodiments, system 100 may be constructed of transparent or translucent material so that the milking process may be visually monitored.

Thus, systems and methods for milking domesticated animals are provided. Persons skilled in the art will appreciate that the described embodiments are presented for the purpose of illustration rather than limitation and the present invention is limited only by the claims that follow.

1. A system for milking domesticated animals comprising:
a sub-mastitic circumferential chamber, wherein the chamber is designed to reach in height from substantially the apex of an animal's teat down to substantially the mid-section of the teat;
a plurality of prominences that line the interior of the sub-mastitic circumferential chamber;
a constant vacuum chamber located below the sub-mastitic circumferential chamber that provides for the conveyance of a constant vacuum; and
a pulse vacuum tube connected to the sub-mastitic circumferential chamber that provides for the conveyance of a pulsating vacuum, wherein the pulse vacuum tube enters the sub-mastitic chamber at a point located above the vertical midpoint of said chamber.

2. The system of claim 1, wherein the pulse vacuum tube is attached to a pulse vacuum means.

3. The system of claim 1, wherein the constant vacuum chamber is attached to a constant vacuum means.

4. The system of claim 1, wherein the plurality of prominences line the interior of the sub-mastitic circumferential chamber in alternating chessboard manner.

5. The system of claim 1, wherein the plurality of prominences line the interior of the sub-mastitic circumferential chamber in at least four substantially horizontal rows about the vertical plane of said chamber.

6. The system of claim 1, wherein the plurality of prominences are constructed from an elastomeric material.

7. The system of claim 1, wherein the pulsed vacuum chamber and the constant vacuum chamber are constructed from an elastomeric material.

8. The system of claim 7, wherein the elastomeric material is transparent.

9. The system of claim 7, wherein the elastomeric material is translucent.

10. The system of claim 1, wherein the plurality of prominences are smooth and rounded.

11. The system of claim 1, wherein the walls of the sub-mastitic circumferential chamber are constructed with varying thicknesses.

12. The system of claim 1, wherein the sub-mastitic circumferential chamber includes an upper and a lower area, wherein the upper area is constructed narrower than that of the lower area.

13. The system of claim 1, wherein the sub-mastitic circumferential chamber gradually decreases in diameter from the upper portion to the lower portion.

14. The system of claim 1, wherein at least one of the plurality of prominences expand and contract with the application of a pulsed vacuum.

15. The system of claim 1, wherein at least one of the plurality of prominences remains in constant contact with the animal's teat.

16. The system of claim 1, wherein the lower portion of the sub-mastitic circumferential chamber remains in constant contact with the animal's teat.

17. A system for milking domesticated animals that operates with vacuum pressures of less than 35 Kilopascal comprising:
a sub-mastitic circumferential chamber, wherein the chamber is designed to reach in height from substantially the apex of an animal's teat down to substantially the mid-section of the teat;
a plurality of prominences that line the interior of the sub-mastitic circumferential chamber;
a constant vacuum chamber located below the sub-mastitic circumferential chamber that provides for the conveyance of a constant vacuum; and
a pulse vacuum tube connected to the sub-mastitic circumferential chamber that provides for the conveyance of a pulsating vacuum, wherein the pulse vacuum tube enters the sub-mastitic chamber at a point located above the vertical midpoint of said chamber.

18. The system of claim 17, wherein the pulse vacuum tube is attached to a pulse vacuum means.

19. The system of claim 17, wherein the constant vacuum chamber is attached to a constant vacuum means.

20. The system of claim 17, wherein the plurality of prominences line the interior of the sub-mastitic circumferential chamber in alternating chessboard manner.

21. The system of claim 17, wherein the plurality of prominences line the interior of the sub-mastitic circumferential chamber in at least four substantially horizontal rows about the vertical plane of said chamber.

22. The system of claim 17, wherein the plurality of prominences are constructed from an elastomeric material.

23. The system of claim 17, wherein the pulsed vacuum chamber and the constant vacuum chamber are constructed from an elastomeric material.

24. The system of claim 23, wherein the elastomeric material is transparent.

25. The system of claim 23, wherein the elastomeric material is translucent.

26. The system of claim 17, wherein the plurality of prominences are smooth and rounded.

27. The system of claim 17, wherein the walls of the sub-mastitic circumferential chamber are constructed with varying thicknesses.

28. The system of claim 17, wherein the sub-mastitic circumferential chamber includes an upper and a lower area, wherein the upper area is constructed narrower than that of the lower area.

29. The system of claim 17, wherein the sub-mastitic circumferential chamber gradually decreases in diameter from the upper portion to the lower portion.

30. The system of claim 17, wherein at least one of the plurality of prominences expand and contract with the application of a pulsed vacuum.

31. The system of claim 17, wherein at least one of the plurality of prominences remains in constant contact with the animal's teat.

32. The system of claim 17, wherein the lower portion of the sub-mastitic circumferential chamber remains in constant contact with the animal's teat.

33. A method of milking a domesticated animal comprising:
providing a sub-mastitic circumferential chamber, wherein the chamber is designed to reach in height from substantially the apex of an animal's teat down to substantially the mid-section of the teat, and wherein the chamber includes an upper and a lower area wherein the upper area of the chamber is constructed narrower than that of the lower area;
providing a plurality of prominences that line the interior of the sub-mastitic circumferential chamber;
providing a constant vacuum chamber located below the sub-mastitic circumferential chamber;
providing a pulsed vacuum to the sub-mastitic circumferential chamber;
providing a constant vacuum to the constant vacuum chamber; and
generating an inductive vacuum between the upper and lower area of the sub-mastitic chamber and the skin of an animal's teat.

34. The method of claim 33, wherein generating the inductive vacuum creates a suction force on the animal's teat.

35. The method of claim 33, wherein generating the inductive vacuum causes the animal's teat sinus to expand in diameter up to one and one third times the initial diameter of the teat sinus.
